(19) United States
(12) Patent Application Publication
(10) Pub. No.: US 2004/0042018 A1
(43) Pub. Date: Mar. 4, 2004

(54) Image processing device, image processing system, image handling tool and image displaying method in image processing device

(75) Inventor: Kazuya Takeuchi, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/228,968

(22) Filed: Aug. 28, 2002

(51) Int. Cl. G06F 3/12; G06F 15/00; G06F 13/00; G06K 15/02

(52) U.S. Cl. 358/1.2; 358/1.15; 358/1.16; 358/1.18

(57) ABSTRACT

The present invention disclosed herein is to provide an image processing device, an image processing system, an image handling tool and an image displaying method in the image processing device, whereby any image processing such as a rotational operation on a reduced image stored in the image processing device is not required and any editing task on the reduced image is enabled to be readily performed in a short time.

The image processing device according to the present invention comprises: an image processing section adapted for processing an image information and an original image storing section adapted for storing therein an original image information obtained from the image processing section, so that an image handling tool is caused to display thereon a reduced image obtained by performing a predetermined image processing operation on an original image based on an instruction issued from the image handling tool. In this case, the image processing device performs an image processing on the original image and, in connection with a reduced image of the original image, causes the image processing section to create a reduced image information group corresponding to one obtained from the result of a plurality of image editing tasks which are performed on the original image by the image processing section based on an instruction issued from the image handling tool and stores therein the created reduced image group. Upon reception of an instruction issued from the image handling tool, a predetermined reduced image of the stored reduced image group is selected so as to display it on the image handling tool.

### BACKGROUND OF THE INVENTION

1. Field of the Invention

The present invention relates to an image processing device, an image processing system, an image handling tool and an image displaying method in the image processing device, which are adapted to browse and edit a reduced image of an original image. More particularly, the present invention relates to an image processing system comprised of an image processing device connectable to a network and an image handling tool operable on a client PC associated with the image processing device via the network, and an image displaying method in the image processing device.

2. Description of the Related Art

There is well known in the art an image processing devices such as multi-function peripherals capable of handling and processing an image. When an original image which has been processed by an image processing section of such a image processing device is stored into an image storing section, the image processing device creates, besides an original image, its reduced image so as to be convenient for its browsing and the like by a user and then stores therein such a reduced image together with the original image.

For example, when the user browses an image stored in the image processing device by using an image handling tool on a client PC which is associated with the image processing device via a network, the reduced image which has been created and stored in such a manner as above will be displayed in behalf of the original image in order to be easier viewable for the user and to alleviate a load on the network, thereby accomplishing a purpose of quickly identifying what kind of images are stored in the image processing device. In the event that the reduced image is displayed intact is in response to a display request from the user, it is possible to quickly display the reduced image without requirement of any image processing of its original image because this reduced image is already being stored in the image processing device together with the original image.

In general, it is much demanded that the reduced image stored in the image processing device is displayed on the image handling tool with any editing operation such as a rotation operation and a reduction (or shrinkage) operation, but not that the reduced image is displayed intact thereon. In this case, the image processing such as the rotation operation of that reduced image based on the editing operation issued from the user must be performed on a side of the image processing device.

FIG. 9 is a flow chart of such an operation as mentioned above. First of all, an image information is stored in an original image storing section through a scanning operation on the side of the image processing device in step 11. In steps 12 and 13, its reduced image is also created and stored therein. Next, in the event that the reduced image obtained after an editing task such as the rotation operation is displayed on the client PC for convenience of a user's browsing, a user's operation by using the image handling tool is performed on the client PC in step 14 and then a predetermined image processing is correspondingly performed on the image processing device in step 15, thereby displaying a rotated reduced image on the client's PC in step 16. A user's desired reduced image is obtained by repeating the operation from the step 14 to the step 16, and then enabling a printing operation to be performed upon an end of that operation in step 17. In addition, an image processing task is performed on the original image so as to be conformable to a state of the image which is displayed on the image handling tool in step 18, thereby enabling its editing task result to be reflected on a final image such as its print.

However, in the event that any editing task such as a rotation operation will be performed on the reduced image on a side of the image handling tool, it can be required for the conventional image processing device as described above to perform the predetermined image processing operation of the step 15 with respect to the reduced image at the expense of a lot of time spent for the image processing operation. As a result, the editing task takes much time, thereby raising problems whereby the editing task is hindered from being rapidly executed.

### SUMMARY OF THE INVENTION

The present invention has been accomplished in view of the circumference as described above, and therefore an object of the present invention is to provide an image processing device, an image processing system, an image handling tool and an image displaying method in the image processing device, whereby any image processing such as a rotation operation on a reduced image stored in the image processing device is not required and any editing task regarding the reduced image is enabled to be readily performed in a short time.

In order to address the above-mentioned problems, there is provided an image processing device according to an aspect of the present invention comprising:

an image processing section adapted for processing an image information;

an original image storing section adapted for storing an information of the original image obtained from said image processing section;

a reduced image group creating instruction section adapted for, in connection with reduced images corresponding to said original image information, causing said image processing section to create a reduced image information group, wherein said reduced image information group corresponds to one which can be obtained from the result of a plurality of image editing tasks which are performed on the original image by said image processing section based on an instruction issued from an image handling tool;

a reduced image group storing section adapted for storing therein the reduced image information group which have been created by said image processing section based on an instruction issued from said reduced image creating instruction section; and

a reduced image selecting section adapted for, in response to an instruction issued from said image handling tool, reading an instructed reduced image information of the reduced image information group stored in said reduced image group storing section.

Also, in the image processing device as above, said reduced image group creating instruction section is adapted for causing said image processing section to create the reduced image information group based on a reduced image group creating pattern information including at least one of an information of a predetermined rotational amount of the reduced image with respect to the original image or an information of the percentage of scale-up/down of the reduced image with respect to the original image. In this case, said reduced image group creating instruction section includes a pattern setting part which is able to variably set said creating pattern information. Furthermore, said image handling tool is operable on a client PC connected to said image processing device via a communication line. In addition, the image processing device can be configured by a multi function peripheral (MFP).

According to another aspect of the present invention, there is provided an image handling tool adapted for operating an image information stored in an image processing device, comprising:

said image processing device adapted for, in connection with a reduced image corresponding to an original image information obtained by said image processing device, storing therein a reduced image information group corresponding to one obtained from the result of a plurality of image editing tasks which are performed by said image handling tool; and

a reduced image selecting instruction section adapted for giving to said image processing device an instruction for reading a predetermined reduced image;

a displaying section adapted for displaying thereon said predetermined reduced image selected from said reduced image information group based on the instruction issued from said reduced image selecting instruction section.

In particular, this image handling tool is operable on a client PC connected to said image processing device via a communication line.

According to yet another aspect of the present invention, there is provided an image processing system having an image processing device and a client PC connected to said image processing device via a communication line, comprising:

said image processing device including:

an image processing section adapted for processing an image information;

an original image storing section adapted for storing therein an original image information obtained from said image processing section;

a reduced image group creating instruction section adapted for, in connection with a reduced image corresponding to said original image information, causing said image processing section to create a reduced image information group corresponding to one obtained from the result of a plurality of image editing tasks which are performed on the original image by said image processing section based on an instruction issued from said image handling tool;

a reduced image group storing section adapted for storing therein said reduced image group which has been created by said image processing section based on an instruction issued from said reduced image group creating instruction section; and

a reduced image selecting section adapted for, in response to an instruction from said image handling tool, giving to said reduced image group storing section an instruction for reading a reduced image information therefrom, and

said client PC having said image handling tool, said image handling tool including:

a reduced image selecting instruction section adapted for giving to said reduced image group storing section an instruction for reading a predetermined reduced image therefrom; and

a displaying section adapted for displaying thereon said predetermined reduced image selected from said reduced image information group based on an instruction issued from said reduced image selecting instruction section.

According to a further aspect of the present invention, there is provided an image displaying method in an image processing device including an image processing section adapted for processing an image information and an original image storing section adapted for storing therein an original image information obtained from said image processing section, said method adapted for causing an image handling tool to display thereon a reduced image obtained by performing a predetermined image processing operation on an original image based on an instruction issued from said image handling tool.

said method comprises the steps of:

upon processing of said original image by said image processing section, in connection with a reduced image of the original image, causing said image processing section to create a reduced image information group corresponding to one obtained from the result of a plurality of image editing tasks which are performed on said original image by said image processing section based on an instruction issued from said image handling tool and to store therein the created reduced image group; and

upon reception of an instruction issued from said image handling tool, selecting a predetermined reduced image of said stored reduced image group.

With the configuration as above, when the image processing device stores therein the original image, a reduced image group obtained after various image processing operations (such as rotation, reduction, expansion and the like) which can be supported by the image handling tool have antecedently been performed on the original image by the image processing device is also stored therein. Upon performing the image editing tasks by using the image handling tool operable on the client PC associated with the image processing device via a network, a desired reduced image can be selected from the reduced image group obtained after various image processing operations have antecedently been performed on the original image and displayed on the image handling tool without any image processing operation per image editing task by a user. As a result, a lot of time spent for the image processing operation is no longer required so that such a desired image is obtained readily and in a short time.

These and other aspects of the present invention will be apparent from the following specific description, given by way of example, with reference to the accompanying drawings.

### BRIEF DESCRIPTION OF THE DRAWINGS

FIG. 1 is a schematic block diagram showing an image processing device and a client PC connected to the image processing device according to an embodiment of the present invention;

FIG. 2 is a conceptual view showing a corresponding relationship between the image processing device and the client PC;

FIG. 3 is a configuration of a local area network environment generally constructed inclusive of the image processing device;

FIG. 4 is an explanatory flow chart of an operation according to the embodiment of the present invention;

FIG. 5 illustrates an initial display screen of an image handling tool on the client PC;

FIG. 6 illustrates a display screen for an instruction to select one of reduced display screens displayed on the initial display screen of the image handling tool;

FIG. 7 illustrates a display screen for an instruction to select an amount of rotation of the reduced display screen selected by the image handling tool;

FIG. 8 illustrates a rotated reduced display screen displayed by the image handling tool; and

FIG. 9 is a flow chart of a conventional operation.

### DESCRIPTION OF PREFERRED EMBODIMENTS

Hereinafter, a preferred embodiment according to the present invention will be described.

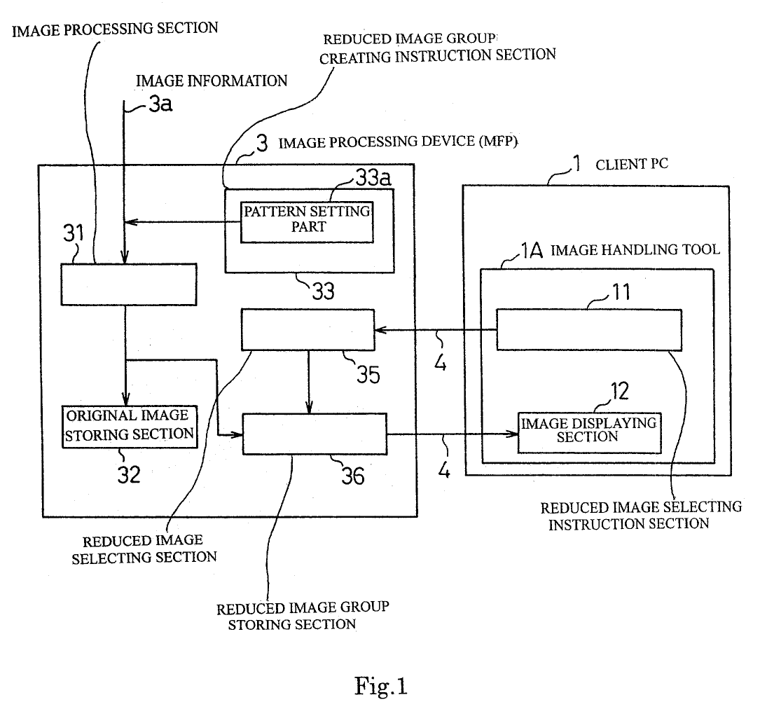

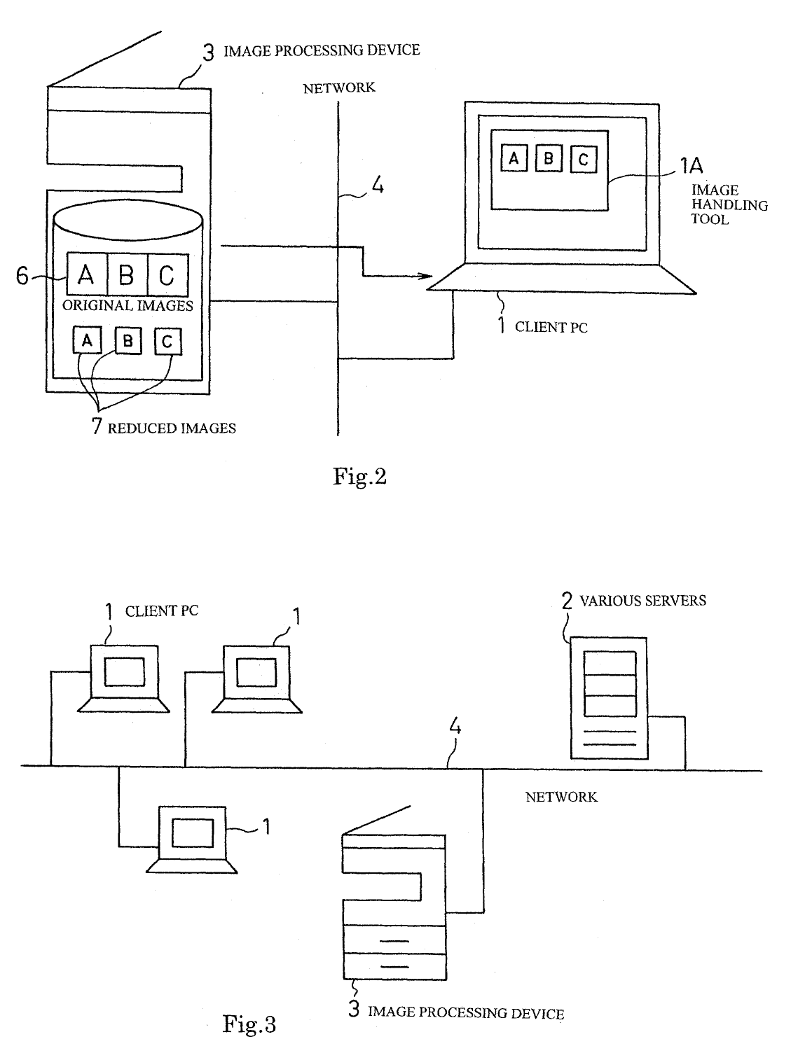

FIG. 1 is a schematic block diagram showing an image processing device and a client PC connected to the image processing device according to an embodiment of the present invention; FIG. 2 is a conceptual view showing a corresponding relationship between the image processing device and the client PC; and FIG. 3 is a configuration of a local area network environment generally constructed inclusive of the image processing device.

As shown in FIG. 3, an environment is constructed such that a plurality of users can commonly use the image processing device since a plurality of client PC 1, various servers 2 and the image processing device 3 are interconnected to each other via a network 4. As shown in FIG. 2, it is possible to perform an operation such as a reference and an edition on an image information (i.e., reduced images 7) held on the image processing device 3 by employing an image handling tool 1A operable on a user's individual client PC 1. In addition, it is also possible to acquire and display their original images 6.

The image processing device (e.g., a MFP (Multi Function Peripheral)) 3 comprises: an image (information) processing section 31 for processing an input image information 3a; an original image storing section 32 for storing therein original images; a reduced image group creating instruction section 33; a reduced image group storing section 34; and a reduced image selecting section 35. Specifically, the reduced image group creating instruction section 33 includes a pattern setting part 33a for setting a creation pattern of a reduced image group (or a group of reduced images) and giving it as a creation pattern instruction to the image processing section in order to obtain such a reduced image group of the original image by antecedently implementing an image editing task to be performed in an image handling tool 1A. The reduced image group storing section 34 for storing reduced images obtained by the image processing section 31 which has performed an image processing operation on the original image according to the creation pattern instruction from the reduced image group creation instruction section 33. The reduced image selecting section 35 for selecting a desired one of a plurality of reduced images stored in the reduced image group storing section 34 based on an instruction from a client PC1 (i.e., the image handling tool 1A).

Also, in the client PC1 includes therein a reduced image selecting instruction section 11 for giving a selecting instruction of a reduced image to the reduced image selecting section 35 of the image processing device 3 and an image displaying section 12 for displaying thereon the reduced image selected from the reduced image group storing section 36 by the reduced image selecting section 35.

In the event that a user conducts the editing task on an image by using image handling tool 1A in the configuration as above, the reduced image selecting instruction section 11 gives a selecting instruction of a reduced image corresponding to that editing task to the reduced image selecting section 35. Subsequently, the reduced image selecting section 35 gives a reading (clipping) instruction of a reduced image information to the reduced image group storing section 36. Upon reception of this reading instruction, the reduced image group storing section 36 transmits a selected reduced image information to the image displaying section 12.

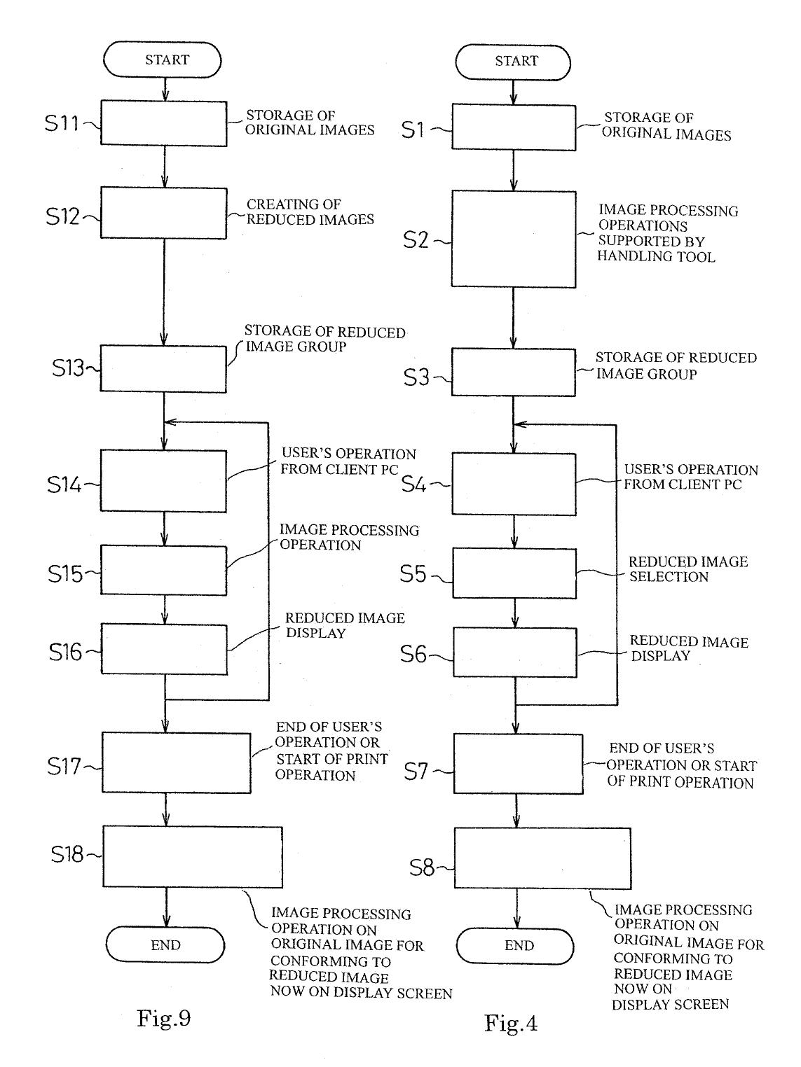

The following description is provided to explain an operation of the image processing system. FIG. 4 is a flow chart showing image processing operations according to the present invention.

First of all, an image information is stored in the original image storing section 32 through a scanning or the like on the side of the image processing device 3 in step S1. Thereafter, reduced images of the original image have been created and stored according to the conventional art (in the steps 12 and 13 as shown in FIG. 9). According to this embodiment of the present invention, however, image processing operations which can be supported by the image handling tool 1A associated with the image processing device via the network are antecedently performed in step S2. Subsequently, a reduced image group created in step S2 (i.e., all of reduced images which can be displayed through the image processing operation performed by the image handling tool 1A) is antecedently stored in the image processing device 3 in step S3.

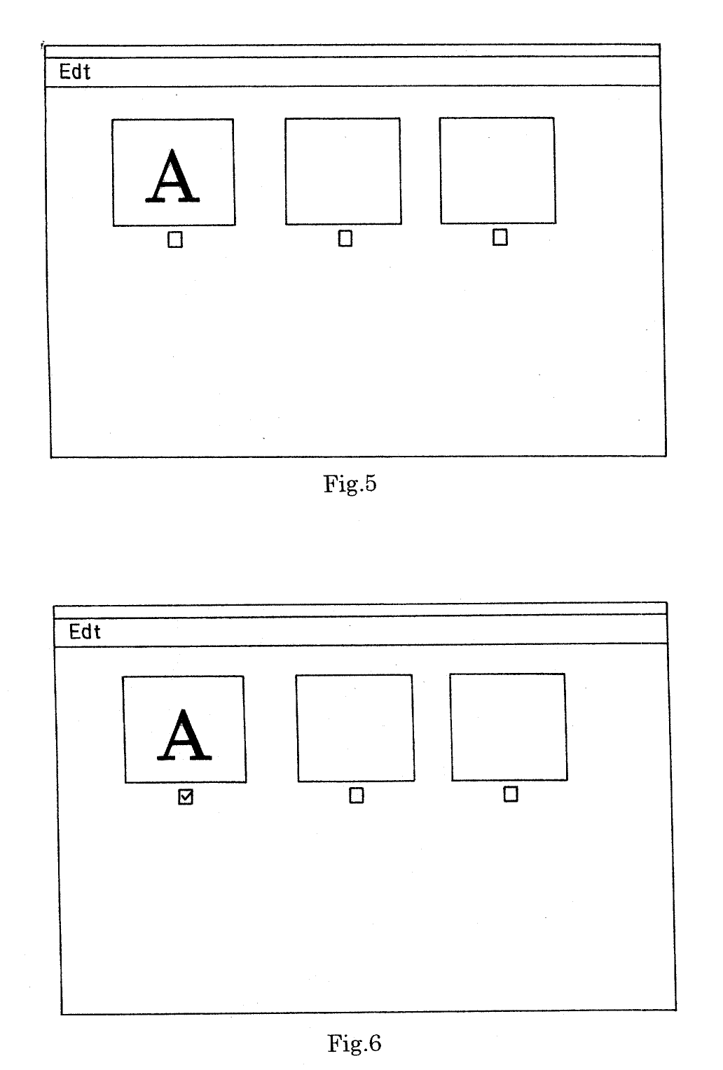

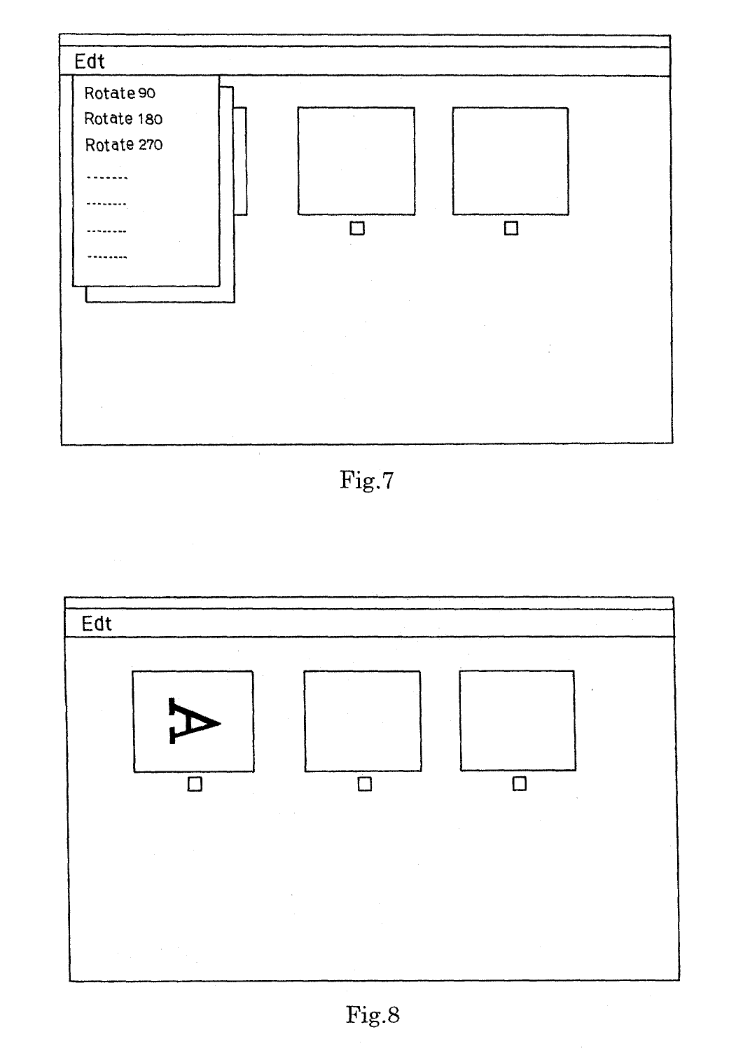

On the other hand, the image handling tool 1A associated with the image processing device 3 via the network displays thereon predetermined reduced images as an initial display screen shown in FIG. 5. In the event that an instruction of an editing task to be performed on these reduced images is issued from a user in step 4, an image processing operation depending on the instruction will be performed in the step 15 of FIG. 9 according to the conventional art. According to this embodiment of the present invention, however, at least one processed reduced image which meets that user's instruction and has antecedently been stored in the image processing device 3 (i.e., the reduced image storing section 32) is selected in step S5, thereby enabling it to be displayed on the client PC. FIGS. 5 to 7 are display screens used depending on various user's instructions. FIG. 5 is the initial display screen as mentioned above. FIG. 6 is a selecting instruction display screen on which a desired reduced image can be selected from the initial display screen (by giving the desired one a check mark). FIG. 7 is rotational amount setting display screen on which an amount of rotation for a selected reduced image can be designated. FIG. 8 is a display screen which is able to shows a final reduced image selected in FIG. 6 and rotated over a rotational amount set on the rotational amount setting display screen as shown in FIG. 7. Thus, since any image processing operation is not required to be performed per edition instruction issued from the user in the conventional art, it is possible to reduce the time spent for displaying the final reduced image on the client PC (i.e. on the image displaying section).

When the user ends the editing task or when the user performs a print operation upon a finalization of editing task with respect to the reduced image where the image processing device is equipped with a print function (step 7), the editing task result can be reflected on a print or the like of the final image by performing an image processing operation for conforming the original image with the reduced image now on the display screen of the image handling tool (step 8).

In this embodiment, the editing task for rotating the reduced image has exemplarily been described as shown in FIG. 7. However, it will be appreciated by those of ordinary skill in the art that the presently reduced image can be further reduced by changing the percentage of scale-down or otherwise conversely expanded. In that case, various rotational or angular amounts as shown in FIG. 7 are substituted with various percentages of scale-down or -up. Furthermore, in this embodiment, the reduced image group creating instruction section 33 within the image processing device gives the image processing section 31 the creation instruction to acquire the group of reduced images which have been obtained by antecedently performing such the image processing operation on the original image as being done by the image handling tool 1A. However, it is also possible instead of the above to give the creating instruction to the image processing section through the reduced image group creating instruction section 33 from the image handling tool 1A on the client PC1. Moreover, in this embodiment, the multi function peripheral (MFP) serves as the image processing device. However, it will be appreciated by those of ordinary skill in the art that the image processing device can be implemented by using an information processing device such as a personal computer.

As is clear from the description as above, it is possible to advantageously acquire a desired image readily and rapidly without a series of image processing operations using the image handling tool by user.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image processing device comprising:
an image processing section adapted for processing an image information;
an original image storing section adapted for storing an information of the original image obtained from said image processing section;
a reduced image group creating instruction section adapted for, in connection with reduced images corresponding to said original image information, causing said image processing section to create a reduced image information group, wherein said reduced image information group corresponds to one which can be obtained from the result of a plurality of image editing tasks which are performed on the original image by said image processing section based on an instruction issued from an image handling tool;
a reduced image group storing section adapted for storing the reduced image information group therein which have been created by said image processing section based on an instruction issued from said reduced image creating instruction section; and
a reduced image selecting section adapted for, in response to an instruction issued from said image handling tool, reading an instructed reduced image information of the reduced image information group stored in said reduced image group storing section.

2. An image processing device as claimed in claim 1, wherein said reduced image group creating instruction section adapted for causing said image processing to create the reduced image information group based on a reduced image group creating pattern information including at least one of an information of a predetermined rotational amount of the reduced image with respect to the original image or an information of the percentage of scale-up/down of the reduced image with respect to the original image.

3. An image processing device as claimed in claim 1, wherein said reduced image group creating instruction section includes a pattern setting part which is able to variably set said creating pattern information.

4. An image processing device as claimed in claim 1, wherein said image handling tool is operable on a client PC connected to said image processing device via a communication line.

5. An image processing device as claimed in claim 1, wherein said image processing device comprises a multi function peripheral (MFP).

6. An image handling tool adapted for operating an image information stored in an image processing device, comprising:
said image processing device adapted for, in connection with a reduced image of an original image corresponding to an original image information obtained by said image processing device, storing therein a reduced image information group corresponding to one obtained from the result of a plurality of image editing tasks which are performed by said image handling tool; and
a reduced image selecting instruction section adapted for giving to said image processing device an instruction for reading a predetermined reduced image;
a displaying section adapted for displaying thereon said predetermined reduced image selected from said reduced image information group based on the instruction issued from said reduced image selecting instruction section.

7. An image handling tool operable on a client PC connected to said image processing device via a communication line.

8. An image processing system having an image processing device and a client PC connected to said image processing device via a communication line, comprising:
said image processing device including:
an image processing section adapted for processing an image information;
an original image storing section adapted for storing therein an original image information obtained from said image processing section;
a reduced image group creating instruction section adapted for, in connection with a reduced image corresponding to said original image information, causing said image processing section to create a reduced image information group corresponding to one obtained from the result of a plurality of image editing tasks which are performed on the original image by said image processing section based on an instruction issued from said image handling tool;
a reduced image group storing section adapted for storing therein said reduced image group which has been created by said image processing section based on an instruction issued from said reduced image group creating instruction section; and
a reduced image selecting section adapted for, in response to an instruction from said image handling tool, giving to said reduced image group storing section an instruction for reading a reduced image information therefrom, and
said client PC having said image handling tool, said image handling tool including:
a reduced image selecting instruction section adapted for giving to said reduced image group storing section an instruction for reading a predetermined reduced image therefrom; and
a displaying section adapted for displaying thereon said predetermined reduced image selected from said reduced image information group based on an instruction issued from said reduced image selecting instruction section.

9. An image displaying method in an image processing device including an image processing section adapted for processing an image information and an original image storing section adapted for storing therein an original image information obtained from said image processing section, said method adapted for causing an image handling tool to display thereon a reduced image obtained by performing a predetermined image processing operation on an original image based on an instruction issued from said image handling tool, comprising the steps of:
upon processing of said original image by said image processing section, in connection with a reduced image of the original image, causing said image processing section to create a reduced image information group corresponding to one obtained from the result of a plurality of image editing tasks which are performed on said original image by said image processing section based on an instruction issued from said image handling tool and to store therein the created reduced image group; and
upon reception of an instruction issued from said image handling tool, selecting a predetermined reduced image of said stored reduced image group.
